(19) United States
(12) Patent Application Publication
(10) Pub. No.: US 2026/0176896 A1
(43) Pub. Date: Jun. 25, 2026

(54) LATCH FOR AUTOMOTIVE VEHICLE WITH CLAW POSITION DETECTION

(71) Applicant: Minebea AccessSolutions France, Alfortville (FR)

(72) Inventors: François DEBROUCKE, Alfortville (FR); Jean-Marc VERBRUGGHE, Alfortville (FR); Jean-Baptiste GRISLAIN, Alfortville (FR)

(73) Assignee: Minebea AccessSolutions France, Alfortville (FR)

(21) Appl. No.: 19/426,697

(22) Filed: Dec. 19, 2025

(30) Foreign Application Priority Data
Dec. 24, 2024 (EP) 24315604

(51) Int. Cl. E05B 81/66

(52) U.S. Cl. CPC E05B 81/66

(57) ABSTRACT

A latch for an automotive vehicle door of the type including a housing in which a claw is pivoting around a first axis between different functional angular positions. The latch also includes at least two switches to determine a functional angular position of the claw. The latch includes a mobile device to be moved by the claw in at least a first and a second position. The mobile device is arranged to place both switches in a first state in the first position of the mobile device and to place both switches in a second state in the second position of the mobile device.

### TECHNICAL FIELD

The present invention relates to a latch for automotive vehicle with claw position detection.

A latch for a motor vehicle door usually comprises a housing in which a claw is pivotally mounted between different functional angular positions. In the closed position of the door, the claw cooperates with a striker carried by a vehicle body, for example a pillar of the vehicle body.

For safety reasons, it is important, when a vehicle is in motion, that each vehicle door can be held in the closed position with no risk of accidental opening, particularly in the event of a vehicle accident or strong vehicle vibrations.

The quality of the cooperation between the striker and the claw is essential to ensure that a vehicle door is held securely in the closed position both in normal conditions of use of the vehicle and in exceptional conditions of use of the vehicle.

Therefore, it is important to detect the position of the claw and the associate status of the latch. This status information is important in some applications of the motor vehicle, for example this status information can be used to activate critical function such as an electrical hand brake or inner lights.

In order to generate this status information, latches usually comprise a switch, which detects a claw position. The signal associated with the switch may be transmitted by a controller to be used in multiple applications. Furthermore, for safety reasons, it may be important to have a redundancy in the detection of the latch status. This redundancy requires several switches to multiply the ways of detection. However, the multiplicity of the switches and their associated signals may become difficult to manage especially in case of desynchronization between the switches.

It is therefore interesting to identify a solution that can activate multiple switches to generate several signals, with or without redundancy, while limiting the number of elements of the latch.

The aim of the invention is in particular to a latch for an automotive vehicle door of the type comprising a housing in which a claw is pivoting around a first axis between different functional angular positions, the latch also comprising at least two switches configured to determine a functional angular position of the claw characterized in that the latch comprises a mobile device configured to be moved by the claw in at least a first and a second position, the mobile device being configured to place both switches in a first state in the first position of the mobile device and configured to place both switches in a second state in the second position of the mobile device.

According to an aspect of the invention, the mobile device comprises a lever pivoting with the claw, and a slider mobile in translation perpendicularly to the first axis by said lever, the mobile slider being movable between at least a first and a second position associated with a first and a second position of the claw, the slider comprising a first contact surface configured to place a first switch in a first state in the first position of the slider and a second contact surface configured to place a second switch in a first state in the first position of the slider, both switches being placed in a second state in the second position of the slider.

According to another aspect of the invention, the first contact surface of the slider is positioned perpendicularly to a translation axis of the slider, the first switch being positioned on a plan parallel to the translation axis of the slider.

According to another aspect of the invention, the first contact surface of the slider is positioned on the side of a finger extending parallel to the translation axe of the slider.

According to another aspect of the invention, the second contact surface of the slider is placed on a first step protruding perpendicularly to the translation axis of the slider.

According to another aspect of the invention, second contact surface of the slider is positioned parallel to the translation axe of the slider, the second switch being positioned on a plan perpendicular to the translation axis of the slider.

According to another aspect of the invention, the latch comprises a third switch, the mobile device being configured to place the third switch in a first state in at least the first position of the mobile device.

According to another aspect of the invention, the slider comprises a third contact surface configured to place the third switch in a first state in the first position of the slider, said third switch being placed in a second state in the second position of the slider.

According to another aspect of the invention, the length, in the direction of the translation axe of the slider, of the second and the third contact surfaces are equal in order to change the state of respectively the second and the third switches simultaneously.

According to another aspect of the invention, the length, in the direction of the translation axis of the slider, of the third contact surface is greater than the length of the second contact surface in order to keep or to place the third switch in its first state when the slider is in an intermediate position.

According to another aspect of the invention, the latch comprises a fourth switch, the mobile device being configured to place the fourth switch in a first state in at least the first position of the mobile device.

According to another aspect of the invention, the slider comprises a fourth contact surface configured to place the fourth switch in a first state in the first position of the slider, said fourth switch being placed in a second state in the second position of the slider.

According to another aspect of the invention, the fourth contact surface of the slider is placed perpendicularly to the translation axis of the slider, the fourth switch being placed on a plan parallel to the translation axis of the slider.

According to another aspect of the invention, the fourth contact surface of the slider is positioned on a side opposed to the first contact surface of the slider and in that the fourth switch is placed in front of the first switch.

### BRIEF DESCRIPTION OF DRAWINGS

The invention will be better understood based on the following description, which is given by way of example only and with reference to the attached drawings in which:

FIG. 1 is a perspective view of a latch,

FIG. 2 is a perspective view of a detection device of the position of the claw according to a first embodiment,

FIGS. 3 to 5 are front views of the detection device according to FIG. 2 in several positions of the claw,

FIG. 6 is a perspective view of a detection device of the position of the claw according to a second embodiment,

FIG. 7 is a perspective view of a detection device of the position of the claw according to a third embodiment.

In these figures, identical elements bear the same reference numbers. The following implementations are examples. Although the description refers to one or more embodiments, this does not necessarily mean that each reference relates to the same embodiment or that the features apply only to a single embodiment. Individual features of different embodiments can also be combined or interchanged to provide other embodiments.

### DETAILED DESCRIPTION

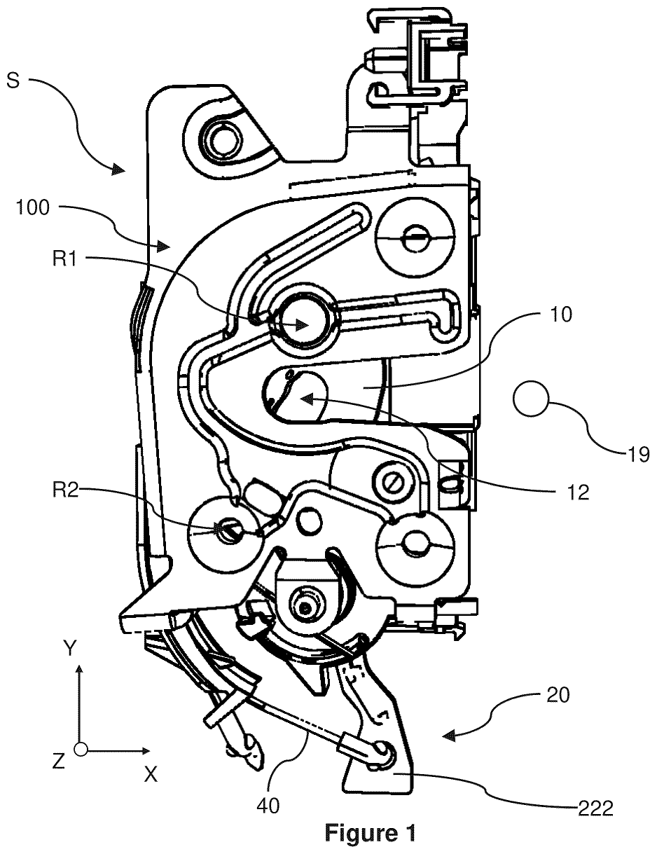

FIGS. 1 to 6 have a trihedron with three axis X, Y and Z. The X axis represents a longitudinal axis corresponding for example to the displacement of an opening panel, for example a door panel or trunk lid, from an open position to a closed position. The Y axis represent a height axis corresponding with an axis perpendicular with the longitudinal axis X, for example the height of the motor vehicle. The Z axis represents a depth axis perpendicular with both the longitudinal axis X and the height axis Y, for example the length of the vehicle.

FIG. 1 shows an electrical latch S for an opening panel of a motor vehicle. The latch S comprises a claw 10 pivoting around a first axis R1 between different functional angular positions. The claw 10 is intended to cooperate with a striker 19. In the examples illustrated in FIG. 1, the first axis R1 is parallel with the depth axis Z. The claw 10 may have a fork-like shape delimiting a notch 12 adapted to receive the striker 19. In the closed position of the latch S, the claw 10 is blocked in rotation at least in one way in order to avoid the release of the striker 19.

The latch S also comprises a release device 20 movable between an initial position and a release position. In its initial position, the release device 20 is configured to block the pivoting of the claw 10 in order to avoid the release of the striker 19.

The latch S may also comprise an electric actuating device (not represented) configured to move the release device 20 from its initial position to its release position.

As shown for example in FIG. 1, the latch S may comprise a housing 100.

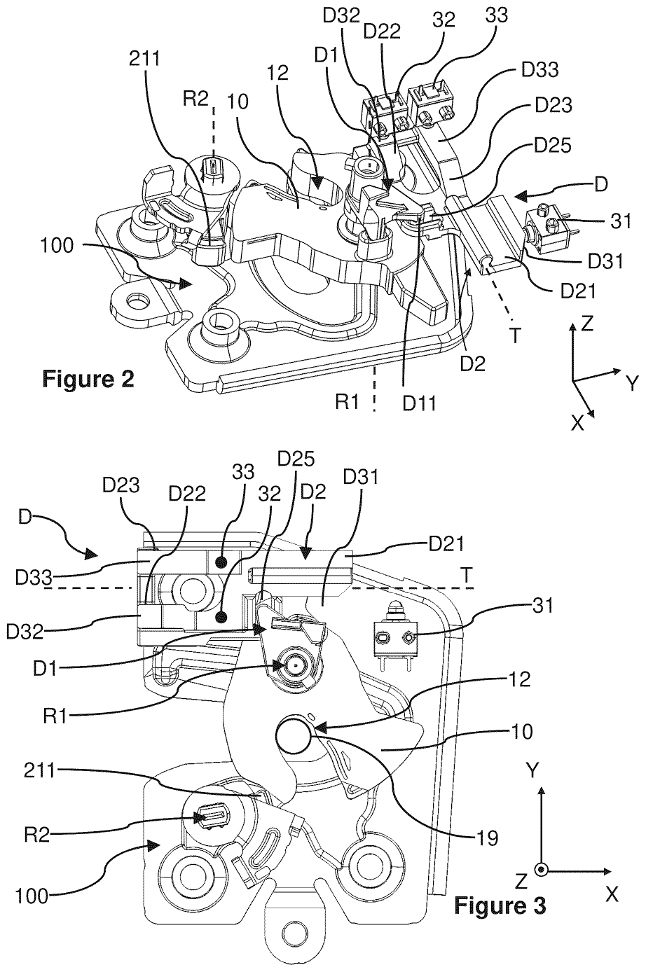

As illustrated in FIGS. 2 to 5, the release device 20 may comprise a pawl 211 intended to be engaged with the claw 10. Thus, in a blocking position, the pawl 211 prevents a pivoting of the claw 10. In a releasing position, the pawl 211 is disengaged from the claw 10, permitting it to pivot. The pawl 211 is pivotally mounted around a second axis R2 parallel to the first axis R1.

The release device 20 may also comprise a manual release lever 222 intended to be linked, for example by a cable 40, to a manual actuating system such as a handle (not represented) in order to manually release the striker 19 from the claw 10.

The latch S comprises at least two switches in order to determine the position of the claw 10. In the example of FIGS. 2 to 6, the latch S comprises three switches 31, 32 and 33.

As illustrated in FIGS. 2 to 6, the latch S comprises a mobile device D configured to be moved by the claw 10 in at least a first and a second position. The mobile device D is configured to place both switches 31, 32 in a first state in the first position of the mobile device D and configured to place both switches 31, 32 in a second state in the second position of the mobile device D. The first state may be associated with the transmission of a signal and the second signal may be associated with an absence of transmission of a signal. Alternatively, the first state may be associated with a first signal level, such as a first voltage, and the second state may be associated with a second signal level, such as a second voltage, different than the first signal level. Using at least two switches 31, 32 allows a redundancy of the signal in case one of the switches 31, 32 is failing.

For example, both switches 31, 32 can be set in the first state when the mobile device D is in its first position, when the claw 10 is in an open position, as illustrated in FIGS. 2 and 5. When the claw 10 is in a closed position, the mobile device D is in its second position and, both switches 31, 32 are in their second state.

The mobile device D may comprise a lever D1 pivoting with the claw 10, and a slider D2 mobile in translation perpendicularly to the first axis R1 along a translation axis T. The mobile device D2 is driven in movement by the lever D1. The lever D1 is preferably pivoting around the same first axe R1 as the claw 10.

The mobile slider D2 is movable between at least a first position associated with the open position of the claw 10 and a second position associated with the closed position of the claw 10. The lever D1 may comprise a pin D11 (illustrated in FIG. 2) at an extremity opposed to the first axe R1 and the mobile slider D2 may comprise an oblong recess D25 into which the pin of the lever D1 is inserted. The oblong recess D25 extends perpendicularly to the translation axis T and the first axe R1.

The mobile slider D2 may have a slide connection with the housing 100 of the latch S.

The slider D2 comprises a first contact surface D31 configured to interact with a first switch 31 to set this first switch 31 in a first state in the first position of the slider D2. The slider D2 also comprises a second contact surface D32 configured interact with a second switch 32 to set this second switch 32 in a first state in the first position of the slider D2. Both switches 31,32 are set in a second state in the second position of the slider D2 due to their interaction (or absence of interaction) with the first D31 and second D32 contact surfaces.

In the example illustrated in FIGS. 2 and 5, the first contact surface D31 sets the first switch 31 in the first state when the slider D2 is in its first position corresponding to an open position of the claw 10. The second contact surface D32 also sets the second switch 32 in the first state when the slider D2 is in its first position.

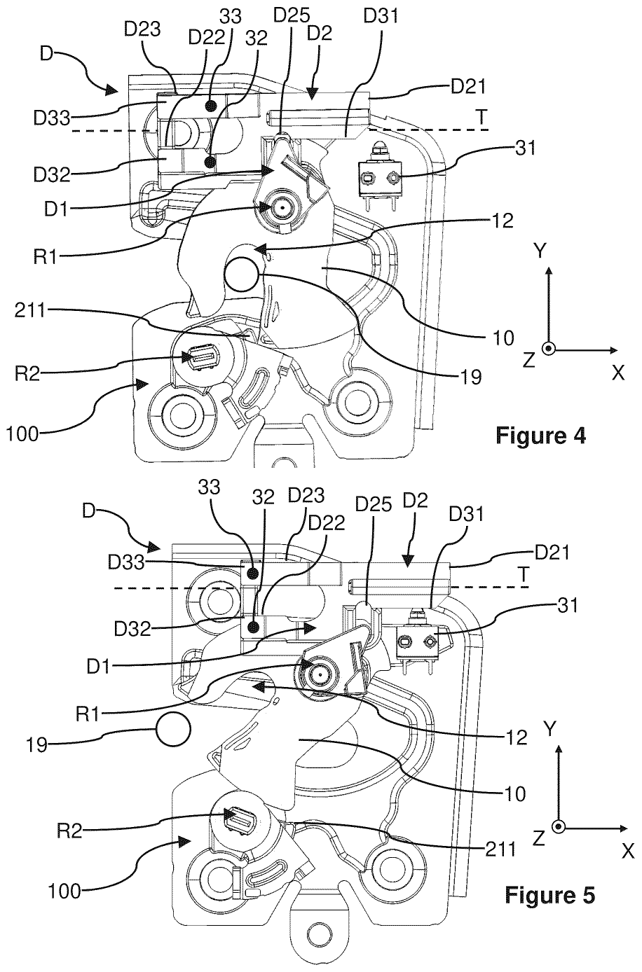

In the example illustrated FIG. 3, the first contact surface D31 is moved away from the first switch 31 when the slider D2 is in its second position corresponding to a closed position of the claw 10 so that the first switch 31 is set in its second state. The second contact surface D32 is also moved away from the second switch 32 when the slider D2 is in its second position so that the second switch 32 is set in its second state.

As illustrated in FIGS. 2 to 6, the first contact surface D31 of the slider D2 may be positioned perpendicularly to the translation axe T of the slider D2. Then, the first switch 31 may be positioned on a plan parallel to the translation axis T of the slider D2. The first contact surface D31 of the slider D2 may be positioned on the side of a finger D21 extending parallel to the translation axe T of the slider D2.

The second contact surface D32 of the slider D2 may be placed on a first step D22 protruding perpendicularly to the translation axe T of the slider D2 (along the axis Z). This first step D22 may comprise an inclined portion extending along the direction of the translation axis T in order to set the second switch 32 in its first or second state depending on the position of the slider D2. This inclined portion may ease the transition of the second switch 32 from the first state to the second state and conversely. The second contact surface D32 of the slider D2 may be positioned parallel to the translation axis T of the slider D2. Then, the second switch 32 may be positioned on a plan perpendicular to the translation axis T of the slider D2 (along the axis X).

As illustrated in FIGS. 2 to 6, the latch S may comprise a third switch 33. The mobile device D is then configured to set the third switch 33 in a first state in at least the first position of the mobile device D.

The slider D2 may then comprise a third contact surface D33 configured to interact with the third switch 33 to set this third switch 33 in a first state in the first position of the slider D2. The third switch 33 may be set in a second state when the slider D2 in the second position.

The third contact surface D33 of the slider D2 may be placed on a second step D23 protruding perpendicularly to the translation axe T of the slider D2 (along the axis Z) D32. This second step D23 may comprise an inclined portion in the direction of the translation axe T in order to set the third switch 33 in its first or second state depending on the position of the slider D2. This inclined portion may ease the transition of the third switch 33 from the first state to the second state and conversely. The third contact surface D33 of the slider D2 may be positioned parallel to the translation axis T of the slider D2 (along the axis X). Then, the third switch 33 may be positioned on a plan perpendicular to the translation axis T of the slider D2 (along the axis Z).

In the example illustrated FIGS. 2 and 5, the third contact surface D33 sets the third switch 33 in its first state when the slider D2 is in its first position corresponding to an open position of the claw 10.

In the example illustrated in FIG. 3, the third contact surface D33 sets the third switch 33 in its second state when the slider D2 is in its second position corresponding to a closed position of the claw 10.

According to a first embodiment illustrated in FIGS. 2 to 5, in the direction of the translation axis T of the slider D2, the length of the third contact surface D33 is greater than the length of the second contact surface D32 in order to keep or to place the third switch 33 in its first state when the slider 32 is in an intermediate position. This intermediate position is for example disclosed in FIG. 4. This particular embodiment permits to have a redundancy with the first 31, the second 32 and the third 33 switches when the slider D2 is in its first position as illustrated in FIGS. 2 and 5. This particular embodiment also allows having a detection of an intermediate position of the slider D2 associated with an intermediate position of the claw 10 as illustrated in FIG. 4.

In the example of FIG. 4, the third switch 33 is set to a first state by the third contact surface D33 when the slider D2 (and the claw 10) are in an intermediate position corresponding for example to a position wherein the striker 19 is retained by the claw 10 but wherein the opening panel is not fully closed.

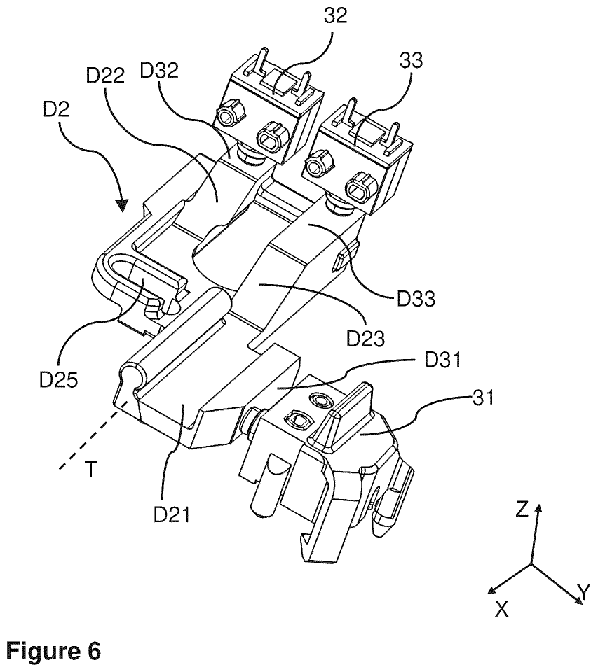

According to a second embodiment illustrated in FIG. 6, in the direction of the translation axe T of the slider D2, the length of the second D32 and the third D33 contact surfaces are equal in order to change the state of respectively the second 32 and the third 33 switches simultaneously. This particular embodiment allows having a redundancy with the first 31, the second 32 and the third 33 switches to detect the first position of the slider D2 associated with the open position of the claw 10 as illustrated in FIGS. 2 and 5.

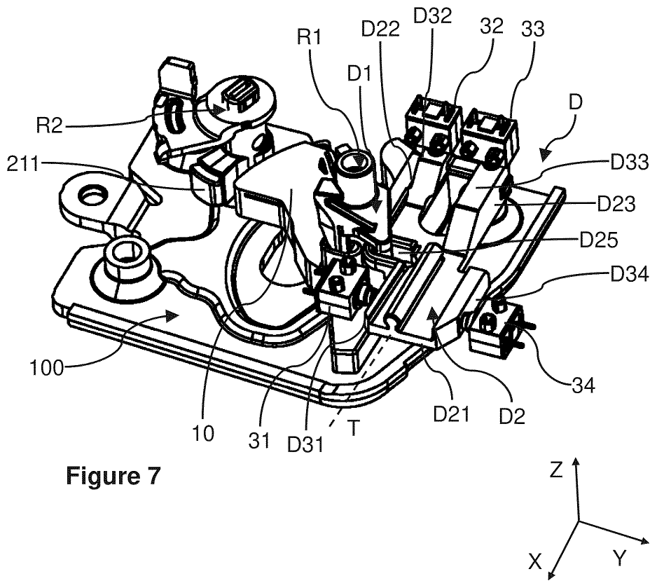

As illustrated in FIG. 7, the latch S may comprise a fourth switch 34. The mobile device D is then configured to place the fourth switch 34 in a first state in at least the first position of the mobile device D.

The slider D2 may then comprise a fourth contact surface D34 configured to place the fourth switch 34 in a first state in the first position of the slider D2. The fourth switch 34 may be placed in a second state in the second position of the slider D2.

The fourth contact surface D34 of the slider D2 may be placed perpendicularly to the translation axis T of the slider D2. The fourth switch 34 may be placed on a plan parallel to the translation axis T of the slider D2.

More precisely, the fourth contact surface D34 of the slider D2 may be placed on a side opposed to the first contact surface D31 of the slider D2. Then, the fourth switch 34 may be placed in front of the first switch 31.

The fourth contact surface D34 may be configured to place the fourth switch 34 in a first state in the first position of the slider D2 and in a second state in the second position of the slider D2 as the same time as one of the first D31, second D32 or third D33 contact surface modify the state of their respective first 31, second 32 or third 33 switch. Then, the fourth switch 34 may be a redundancy of one of the other switches 31, 32, 33.

### LIST OF REFERENCES

S: latch
10: claw
R1: first axis
19: striker
20: release device
100: housing
211: pawl
R2: second axis
222: release lever
40 cable
31: first switch
32: second switch
33: third switch
34: fourth switch
D: mobile device
D1: lever
D11: pin
D2: slider
D25: oblong recess
D31: first contact surface
D32: second contact surface
D33: third contact surface
D34: fourth contact surface
D22: first step
D23: second step

1-14. (canceled)

15. A latch for an automotive vehicle door comprising:
a housing in which a claw is configured to pivot around a first axis between different functional angular positions;
at least two switches configured to determine the functional angular position of the claw; and
a mobile device configured to be moved by the claw in at least a first and a second position, the mobile device being configured to place both switches in a first state in the first position of the mobile device and configured to place both switches in a second state in the second position of the mobile device.

16. The latch according to claim 15, wherein the mobile device comprises a lever configured to pivot with the claw, and a slider mobile in translation perpendicularly to the first axis by said lever, the mobile slider being movable between at least a first and a second position associated with the first and the second position of the claw, the slider comprising a first contact surface configured to place the first switch in the first state in the first position of the slider and a second contact surface configured to place the second switch in the first state in the first position of the slider, both switches being placed in the second state in the second position of the slider.

17. The latch according to claim 16, wherein the first contact surface of the slider is positioned perpendicularly to a translation axis of the slider, the first switch being positioned on a plan parallel to the translation axis of the slider.

18. The latch according to claim 17, wherein the first contact surface of the slider is positioned on a side of a finger extending parallel to the translation axe of the slider.

19. The latch according to claim 17, wherein the second contact surface of the slider is placed on a first step protruding perpendicularly to the translation axis of the slider.

20. The latch according to claim 17, wherein the second contact surface of the slider is positioned parallel to the translation axe of the slider, the second switch being positioned on a plan perpendicular to the translation axis of the slider.

21. The latch according to claim 16, further comprising:
a third switch, the mobile device being configured to place the third switch in a first state in at least the first position of the mobile device.

22. The latch according to claim 21, wherein the slider comprises a third contact surface configured to place the third switch in the first state in the first position of the slider, said third switch being placed in a second state in the second position of the slider.

23. The latch according to claim 22, wherein a length, in a direction of a translation axis of the slider, of the second and the third contact surfaces are equal in order to change the state of respectively the second and the third switches simultaneously.

24. The latch according to claim 22, wherein a length, in a direction of a translation axis of the slider, of the third contact surface is greater than a length of the second contact surface in order to keep or to place the third switch in the first state when the slider is in an intermediate position.

25. The latch according to claim 16, further comprising:
a fourth switch, the mobile device being configured to place the fourth switch in a first state in at least the first position of the mobile device.

26. The latch according to claim 25, wherein the slider comprises a fourth contact surface configured to place the fourth switch in the first state in the first position of the slider, said fourth switch being placed in a second state in the second position of the slider.

27. The latch according to claim 26, wherein the fourth contact surface of the slider is placed perpendicularly to a translation axis of the slider, the fourth switch being placed on a plan parallel to the translation axis of the slider.

28. The latch according to claim 27, wherein the fourth contact surface of the slider is positioned on a side opposed to the first contact surface of the slider and the fourth switch is placed in front of the first switch.
